(19) United States
(12) Patent Application Publication
(10) Pub. No.: US 2003/0018812 A1
(43) Pub. Date: Jan. 23, 2003

(54) Method and apparatus for provisioning working paths in shared protection mesh network

(76) Inventors: Ganesh Lakshminarayana, Plainsboro, NJ (US); Santhanam Srinivasan, Holmdel, NJ (US); Jayanta Das, Morganville, NJ (US)

Correspondence Address: KAPLAN & GILMAN , L.L.P., 900NROUTE 9 NORTH, WOODBRIDGE, NJ, 07095, US

(21) Appl. No.: 10/004,352

(22) Filed: Oct. 25, 2001

Related U.S. Application Data
(60) Provisional application No. 60/306,273, filed on Jul. 18, 2001.

(51) Int. Cl. G06F 15/173

(52) U.S. Cl. 709/241

(57) ABSTRACT

An improved technique for provisioning working paths and protection paths is disclosed in which the “inferiority” of various links from each node to a “next hop” is examined. Choices are eliminated at each step before plural choices are evaluated at the next step, until the best working paths and protection paths through the network are established.

### CROSS REFERENCE TO RELATED APPLICATIONS

This application claims the benefit of U.S. Provisional Patent Application Serial No. 60/306,273, filed on Jul. 18, 2001.

### TECHNICAL FIELD

This invention relates to telecommunications, and more specifically, to an improved method and apparatus for provisioning working paths and protection paths for communications in optical and other types of data networks.

### BACKGROUND OF THE INVENTION

Large telecommunications networks have become prevalent. Many of these networks are implemented in a mesh format, meaning that communications links are connected among numerous communication nodes in a mesh type of pattern. Mesh networks provide a better cost reliability tradeoff than rings or other architectures. However, it is much more difficult to provision available bandwidth in a mesh topology efficiently and economically than is the case with the other architectures. The provisioning problem results from the fact that there can be a tremendous number of possible paths through a mesh network between a source and destination node. Finding the best path, and finding appropriate backup paths for use in the event of one or more failures, is a computationally expensive process, so much so that it is usually computationally impractical.

FIG. 1 shows an example of nodes 0-24 connected in a mesh topology to form a network. Each of the nodes 0-24 represents a communications node which may be, for example, an optical router. Each of the links (e.g. 110) represents a connection from one node to another. Each such connection is characterized by a bandwidth or capacity representing the data rate that the link can support. In optical network systems, typically multiple wavelengths are multiplexed onto a single optical fiber, and the link 108 may be characterized by the number of possible wavelengths that can be placed onto one link. For example, those of skill in this art refer to the links as supporting “40 lambdas”, meaning that forty different wavelengths are multiplexed onto each link.

At this point, it is helpful to set forth a few definitions for use in explaining the prior art and the present invention. We define a working path as a set of links from a specified source node to a specified destination node for use in transmitting data from the source node to the destination node during normal operation. For example, the working path from source node 0 to destination node 24, which we designate as working path W, might be comprised of links 102 through 109.

We define a protection path as a backup path for a particular working path, which will be used in the event of any failure along the working path. For example, a potential protection path for working path W, designated as P, could, for example, comprise links 110-117.

One goal of provisioning working paths and protection paths is to allow for securing a simple method of switching over from the working path to the protection path in the event of a failure of any link or node along the working path. In order to avoid having multiple protection paths for a single working path, it is preferred to have a working path that is node disjoint and link disjoint with respect to its protection path, thus preventing a single failure from disabling the working and protection paths simultaneously. This disjoint requirement means that the working path and the protection path share no links or nodes between the source node and the destination node. Such a technique means that as soon as communications fails between the source and destination node, the system will know exactly how to switch over to the protection path, without first having to diagnose where in the system along the working path the fault is, and then selecting the protection path for this protection path for this particular failure. Instead, as soon as communications fails, switching over to the unique protection path P protect against the failure of any node or any link in the working path W.

Another goal in provisioning protection paths for backup use if a working path fails in a mesh network is to allow for shared backup. This technique takes advantage of the fact that it is unlikely that two independent failures in the system will occur at the same time. Thus, if two working paths are both node and link disjoint with respect to one another, it means that no single failure can require both of the working paths to switch over to a backup path. It follows then, that the protection paths for two such working paths which are both node disjoint and link disjoint can share the same protection resources.

The prior art recognizes the desirability of providing for shared backup, and for providing working paths that are node disjoint and link disjoint with respect to each other and with respect to protection paths. However, given a network topology, link characteristics, and a present state of a network (i.e. already provisioned paths), the provisioning of a new working path between given source and destination nodes is no easy task. A brute force method of simply trying every path through the network and eliminating those that don't work or are inefficient until an optimal one is found, is computationally prohibitive.

Algorithms exist for avoiding the tremendous number of calculations required if the brute force approach described above is used. One such algorithm is known in the art as Dijkstra's algorithm. Dijkstra's algorithm solves the problem by traversing the network section by section, picking an optimal link at each section. However, a problem with Dijkstra's algorithm is that it may select a working path for which there is no adequate node and link disjoint protection path.

In view of the foregoing, there exists a need in the art for an improved technique of provisioning working paths and protection paths, given parameters of the network, where such parameters include link costs, network topology, bandwidth, and the already provisioned paths of the network.

It is an object of the invention to find a working path between a source/destination pair, as well as a node and link disjoint protection path, which has sufficient bandwidth to protect the working path in case of a single node or link failure.

It is an object of the invention to provision such working paths and protection paths in a manner that is computationally efficient.

It is an object of the invention to provision a working and protection path that use a minimal amount of overall bandwidth in the network. To this end, the combined costs of the working and protection paths should be as low as possible.

The above and other objects of the invention will become clearer upon a review of the following description of the invention in conjunction with the accompanying figures.

### SUMMARY OF THE INVENTION

The above and other problems of the prior art are overcome in accordance with the present invention that relates to a technique of provisioning working paths and protection paths between a given source and destination node. In accordance with the invention, a “frontier” of nodes is created, and the frontier propagates from node to neighboring node across the network, beginning with the source node.

At each stage, each node in the frontier is examined and inferior paths to that node are discarded while one or more non inferior paths are maintained. When the frontier completes propagating through the network to the destination node, a list of candidate non inferior paths exists.

From the list of candidate non inferior paths, a protection path for each is calculated, and total path cost is also calculated as a combination of the protection path cost and the working path cost. The pair of paths with the lowest combined cost is then selected as the working path and its protection path.

The algorithm utilizes a novel technique of calculating the cost of working paths by utilizing, in a preferred embodiment, an ordered pair. The first entry in the ordered pair represents the sum of costs of link usage for links in the path, and the second entry in the ordered pair represents a measurement of the sum of the bandwidths affected by a single fault on the working path, i.e., a failure on any link or node that constitutes the working path. This second parameter makes more costly, and thus less desirable, working paths that intersect with other working paths. Working paths which are provisioned on the same fiber would be failed by the same fiber cut. Therefore, two working paths which are provisioned on the same fiber cannot share protection resources. The second parameter accounts for this effect by penalizing working paths that share the same fiber as already provisioned working paths. As a result, the algorithm tries to select working paths that do not overlap anywhere along the length thereof, which maximizes the use of protection path sharing.

In several embodiments, combinations of various cost parameters are utilized to calculate a true cost parameter, wherein the combinations may be selected by a user based upon the particular requirements and priorities of the user.

### BRIEF DESCRIPTION OF THE DRAWINGS

FIG. 1 depicts a exemplary mesh topology for a network which may be provisioned in accordance with the techniques of the present invention;

FIG. 2 is an exemplary working path of node 0 to node 24 within the network of FIG. 1;

FIG. 3 shows an exemplary second working path W2 from source node 1 to destination node 24; and

FIG. 4 shows a flow diagram of an exemplary algorithm for use in connection with the present invention.

### DETAILED DESCRIPTION OF THE PREFERRED EMBODIMENT

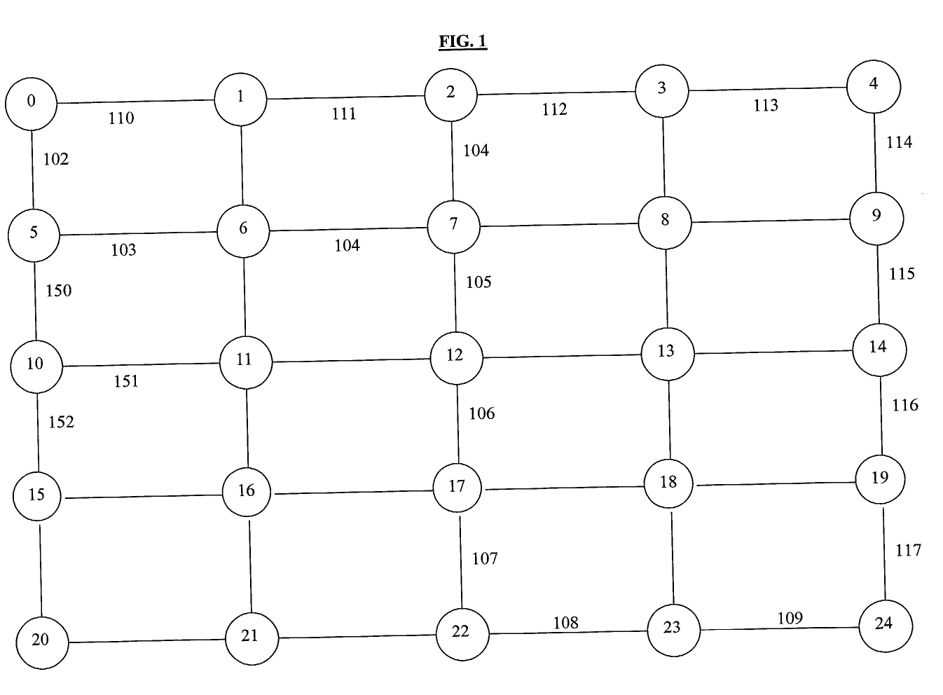

FIG. 1 shows an exemplary mesh network including nodes 0 through 24, interconnected by plural links. Several of the links are numbered for purposes of explanation herein.

We first describe the technique of the present invention in general terms using an example. Thereafter, we turn to the specific steps of the algorithm and, describe them in detail so that the technique can be implemented in hardware and/or software and utilized for selection of working paths and protection paths.

The problem can be stated as follows:

A provisioning system is given several pieces of information:

1. A network topology, which includes nodes, links, and capacities or bandwidths of each link;

2. Presently provisioned working paths and protection paths;

3. A link cost function which presents an economic or other measure of cost of traversing each link in the network, where each link may have a different cost; and

4. A source and destination node pair; representing the two nodes between which it is desired to provision a working path and a protection path.

The problem is, given the foregoing information, find a working path W and a protection path P such that W and P are node and link disjoint, and the combined cost of W and P is minimized.

We also note that, presuming protection path sharing, the bandwidth in a link is consumed by all protection paths of disjoint working paths on that link is not the sum of the bandwidth of each protection path, but is instead simply the maximum bandwidth consumed by any single protection path that traverses the link. This is because, for example, the first protection path traversing the link consumes 50 lambda, and a second protection path traversing the link consumes 70 lambda, both of the protection paths will not be utilized at the same time.

We also define herein a Shared Risk Link Group (SRLG). It is a set of links in a network that can be failed by a single fiber cut or fault. Different wavelengths (lambdas) on the same optical fiber belong to the same SRLG. Also, if several fibers share a trench, the lambda channels on these fibers would constitute an SRLG.

Referring first to FIG. 1, we describe in general how a “frontier” propagates through the network in order to find optimal working paths and protection paths which are disjoint. The system is attempting to find a set of candidate working paths from source node 0 to destination node 24.

First, the frontier is defined by the neighboring node of source node 0 moving toward destination node 24. This means the frontier becomes the set of nodes 1 and 5 in FIG. 1. In each of the set of nodes 1 or 5, we add to the frontier the neighboring nodes. Thus, considering node 5 first, the frontier now includes neighboring nodes 10 and 6. Considering then node 1, the frontier would include neighboring nodes 2 and 6. For each node in the frontier, we calculate a cost function of potential paths to that node. In our example, when the frontier is comprised of nodes 2, 6 and 10, paths for which a cost would be calculated would include the following:

Candidate work path 1 0, 5, 10

Candidate work path 2 0, 5, 6

Candidate work path 3 0, 1, 6

Candidate work path 4 0, 1, 2

That set of four possible paths through the nodes is the four possible paths to each of the three nodes in the frontier.

In accordance with the present invention, any nodes in the frontier which have multiple paths to them, (e.g. node 6) are then examined to determine of any of the plural paths are “inferior”, where “inferior” is explained further below. Therefore, the path to node 6 through node 5 would be examined and compared with path to node 6 through node 1. If neither path is inferior, then both will be kept, whereas if one of the two paths is inferior, the inferior path will be discarded. Thus, at the point in the execution of the algorithm when the frontier is comprised of nodes 2, 6 and 10, there will be either three or four potential paths, depending upon whether one of the paths to node 6 is inferior and thus discarded. These paths, as defined by their nodes, include 0, 1, 2; 0, 5, 10, and one or both of 0, 1,6 and 0,5,6. At that stage, each of the nodes 2, 6 and 10 is examined in the same manner as previously discussed. More specifically, with respect to node 10, its neighbors are 11 and 15, and thus the paths to 11 and 15 through 10 are discovered. This path includes links 102, 150 and 152 to node 15, links 102, 150 and 151 to node 11. The second node in the frontier is node 6, and thus the paths from node 6 to node 7 and 11 are examined, after which the paths of neighboring nodes of node 2 are examined leading to an analysis of path comprised of links, 110, 111 and 104, as well as 110, 111 and 112. At this later stage now in the algorithm, the frontier consists of nodes 3, 7, 11 and 15. The paths to each of these four nodes are now examined, with inferior paths to each node discarded, leading to still another recursion, etc. When the frontier ends and, a set of candidate paths to destination node 24 exists.

Each of the potential candidate paths includes an ordered pair which represents its cost. The ordered pair may be combined in a manner as discussed below in order to determine a specific path cost.

In addition to the foregoing, for each of the candidate paths, the protection path is calculated using a conventional technique such as Dijkstra's algorithm. The total cost of the working path and protection path are then combined, and the path with the lowest total combined cost is then selected.

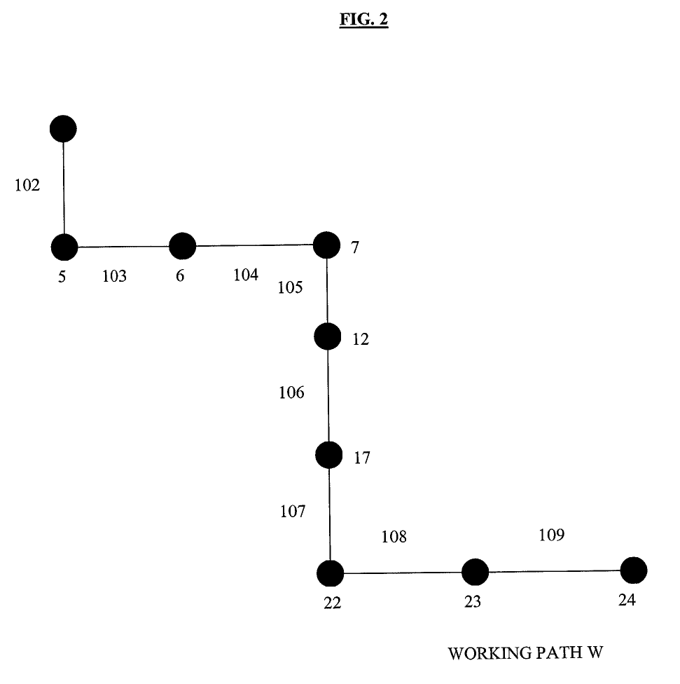

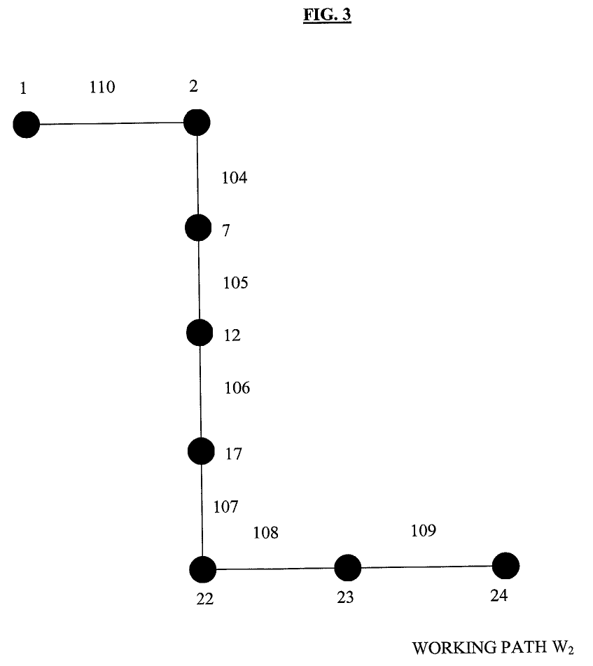

As the frontier propagates through the network from source node to destination node, and the paths are evaluated, a specific ordered pair is utilized in order to determine whether or not one path is inferior to another path. The first entry in the ordered pair is the total cost of the links belonging to such paths. For purposes of demonstrating the ordered pair, we refer to FIGS. 2 and 3. FIG. 2 shows a working path W through the mesh network of FIG. 1, which working path traverses the nodes 0, 5, 6, 7, 12, 17, 22, 23 and 24 as shown. An additional working path from node 1 through node 24 is shown in FIG. 3. Path W is protected by protection path P which traverses nodes 0, 1, 2, 3, 4, 9, 14, 19, and 24. W consumes one lambda, and therefore, P, which protects W, would also consume one lambda.

We define a “blocking potential” of a path as the sum of the bandwidths protected by the Shared Resource Link Groups (“SRLG”) that links on the path belong to. Consider the candidate working path W2, which traverses nodes 0, 1, 2, 7, 12, 17, 22, 23, 24. W2 and W overlap on link 7-12. Therefore, if the link 7-12 fails, protection path P, which protects W, will be activated. This would remove eight lambdas from the network. Therefore, the blocking potential for candidate working path W2 is 8.

By calculating the ordered pair for each of the potential working paths in each stage of the frontier above, a set of candidate working paths exists at the end of the algorithm. Candidate working paths will each have a first and second value, representing the link cost and blocking potential respectively. Thus, an example set of candidate working paths might be as follows: (7, 8); (8, 4), (10, 0).

Note that none of the foregoing working paths can be deemed inferior. This is because inferior for purposes herein is defined as both the first and second values in the ordered pair are worse. Thus, a working path with an ordered pair of (12, 12) would be inferior to any of the foregoing because both entries in the ordered pair are worse.

It is noted that in the exemplary embodiment described herein, if the first entry in the ordered pair is less and the second entry in the ordered pair is more, then neither ordered pair is deemed inferior. The user may alter the algorithm for determining which of the ordered pairs is inferior. For example, if blocking potential is deemed more or less important than link cost, the user may compare two ordered pairs after assigning a relative weight to each entry in the ordered pair. In any event, some comparison algorithm is used to discard inferior pairs.

When the frontier is complete and the destination node reached, each ordered pair is compressed into a single value by taking a weighted average (or some other positive monotonic function) of the two entries in the ordered pair Thus, if there are four candidate working paths when the frontier ends, the output of the algorithm will be converted to four single numbers. The working path associated with each number will then be processed using a standard algorithm such as Dijkstra's algorithm to determine a protection path. The protection path cost is then added to the single number corresponding to the working path cost, and the working path and protection path pair with the lowest combined cost is selected.

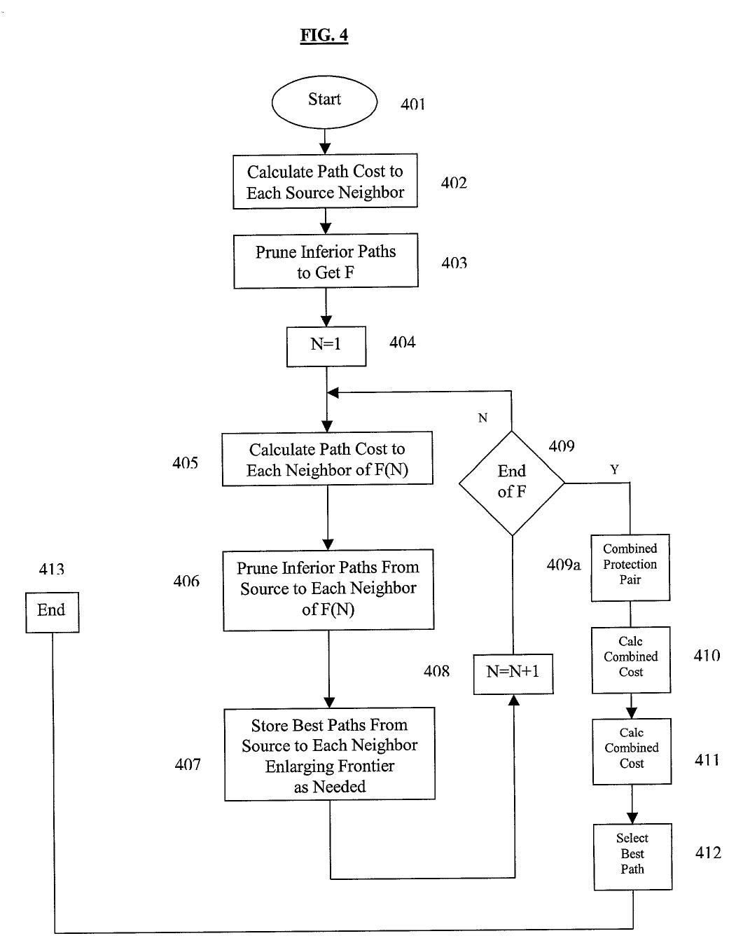

Referring now to FIG. 4, shown therein is a flow chart for implementing an exemplary embodiment of the present invention. The algorithm is entered at start 401 and at block 402, a path cost, (i.e. ordered pair) is calculated for paths from the source node to each neighbor of the source node. This would be, for example, paths 102 and 110 in FIG. 1. In block 403, any inferior paths to a specific node are “pruned”, or discarded. In the example given, since there is only one path to each of the two nodes, there can be no inferior paths to either of the nodes, and therefore both paths are maintained and no pruning occurs. In block 404, the index N for the frontier F is set equal to 1 and the loop propagating the frontier is then entered.

The first step in the prorogation loop 405 is to calculate the path cost for a path from the source node to each neighbor of the node being considered, for example, node 5. If plural paths exist to the particular node of the frontier, then block 406 will prune off each inferior node so that only nodes that are equal to superior will remain. Last, block 407 stores all the best paths from the source node to each neighbor of the node N being considered, and enlarges the frontier F as new nodes are added, as previously described.

The next node in the frontier is then indexed at block 408 and assuming the frontier has not ended, decision point 409 transfers control back to block 405 for calculating the next set of paths to the neighbors of the next node in the frontier. The process continues until the end of the frontier is reached, thereby leaving a set of ordered pairs that represent equal non-inferior paths to the destination. The ordered pairs may be combined into a single value at block 409A, which gives a single index indicative of the cost of the paths accounting for both its blocking potential as well as link costs. Block 410 then calculates protection paths using, for example, Dijkstra's algorithm, for each such working path. The cost calculated in 409A and the cost of the protection path in 410 for each working path protection path pair are then combined using a weighted average of block 411 and the results transferred to block 412 for selection of the best optimal combination of working paths and protection paths. Typically, such combination will be chosen to be that with the least combined cost.

The above is by way of example, not limitation. Other embodiments and variations will be apparent to those of skill in the art.

What is claimed is:

1. A method of calculating a blocking potential parameter for a potential working path in a communications network, the path being comprised of plural links, the method comprising the steps of adding up a cost assigned to each link to form a first cost and adding up the total bandwidth of other communications paths which share resources with said potential working path to form a second cost.

2. A method comprising performing the method of claim 1 with respect to plural potential working paths, and discarding some of said plural working paths as inferior to leave a set of candidate working paths.

3. The method of claim 2 wherein a potential working path is deemed inferior to a second path if both the sum of the cost assigned to each link in the potential working path and said blocking potential are both less than said cost assigned to each link and said blocking potential for said second path.

4. The method of claim 2 further comprising the step of combining the first and second costs to form a third cost.

5. The method of claim 4 further comprising the step of calculating a protection path for each candidate-working path.

6. The method of claim 5 further comprising the step calculating a cost for each protection path.

7. The method of claim 6 further comprising the step of calculating a combined cost of said working path and said protection path.

8. A method of provisioning working and protection paths from a source node to a destination node in a network, the network being comprised of plural links, each of said links having an associated capacity, the network having previously provisioned working paths and protection paths, the network also comprising plurality of nodes that are interconnected by the links, the nodes having neighbors, the method comprising the steps of:
a. calculating a cost of each working path from said source node to each neighbor of said source node to achieve a set of candidate paths from said source to each of said neighbors, the set of neighbors constituting initially a frontier;
b. pruning said set of candidate paths by removing inferior paths;
c. for each node in the frontier or added to the frontier, calculating a cost working paths from said source node to each neighbor of said each node in the frontier and supplementing said candidate paths by adding to said candidate paths any of said working paths calculated in this step c that are less costly than candidate working paths from said source node to said neighbor of said node for which a cost has already been calculated, and discarding any candidate paths to said neighbor of said node that are inferior;
d. adding all neighbors of said node for which a candidate path is calculated to the frontier;
e. when step c has been executed for each node in the frontier, selecting an optimal working path.

9. The method of claim 8 wherein said step a of calculating includes the step of calculating at least two values associated with each path.

10. The method of claim 9 wherein at least one of said values is comprised of a blocking potential, representing the sum of bandwidths protected by the SRLG's that a candidate working path belongs to, and wherein an SRLG is a set of links that may fail based upon a single network fault.

11. The method of claim 8 wherein step e comprises the steps of selecting a protection path for each of said candidate working paths, assigning a protection cost to each protection path, and calculating a combined cost by combining a cost of said protection path with a cost of said each candidate working path.

12. The method of claim 11 wherein the protection paths are calculated using Dyjkstra's algorithm.

13. The method of claim 11 wherein protection paths are assigned a cost that accounts for the sharing of protection paths.
